(19) United States
(12) Patent Application Publication
(10) Pub. No.: US 2024/0225028 A1
(43) Pub. Date: Jul. 11, 2024

(54) MEAT ALTERNATIVE PRODUCT AND PROCESS

(71) Applicant: PLANT MEAT LTD, London (GB)

(72) Inventors: Emily BOWERS, London (GB); Ellen WRIGHT, London (GB); Peter SHARMAN, London (GB); Andy SHOVEL, London (GB); Luke BYRNE, London (GB); Linda BELLEKOM-ALLEN, Collingham, Newark, Nottinghamshire (GB); Kelsey KANYUCK, London (GB)

(21) Appl. No.: 18/559,297

(22) PCT Filed: May 5, 2022
(86) PCT No.: PCT/EP2022/062217

§ 371 Date: Nov. 6, 2023

(30) Foreign Application Priority Data
May 7, 2021 (GB) 2106572.7

(51) Int. Cl. A23D 7/005; A23J 3/14; A23J 3/22; A23L 29/206

(52) U.S. Cl. CPC A23D 7/0053; A23J 3/14; A23J 3/227; A23L 29/206

(57) ABSTRACT

The present invention relates to a plant based fat composition for meat analogues comprising a glucomannan gum, a fat, a browning agent; a coagulating agent; and water. The invention also relates to a process for preparing the fat composition and to a meat analogue containing the fat composition. The fat composition ensures that the meat analogue is crispy on the outside when heated (fried, baked) while maintaining a chewy texture throughout.

### FIELD OF THE INVENTION

The present invention relates to a food product and process. In particular, the invention relates to a plant based fat composition and a method of producing the fat composition. The fat composition can be used in meat analogues, for example in vegetarian or vegan bacon, sausage and burger analogues.

### BACKGROUND

Veganism and vegetarianism is an increasingly common lifestyle choice around the globe, and particularly in the UK and USA. Veganism is defined as not consuming dairy, meat, fish or egg products. This means that their diet must consist of plant based food products that maintain the highest sources of nutrients. Vegetarianism is defined as the practice of not eating meat or fish. As a result of this change in eating habits among the general population there is an increased demand for meat free protein products and meat alternatives.

Additionally, issues around health, sustainability, traceability and animal welfare are also increasingly important influences in consumer purchasing decisions. As a result, meat free protein products are no longer exclusively sold to the consumer group that identifies as vegetarian or vegan. A flexible diet is becoming increasingly popular and the appeal of plant based foods is broadening to include people who also incorporate meat and dairy in their diets but also wish to seek meat alternatives sometimes.

Meat analogues are prepared such that they resemble meat as much as possible in appearance, taste and texture. Meat analogues are typically prepared from proteinaceous fibres of non-meat origin. Raw material from various sources (wheat, soy, pea, chickpea, fava bean, lupine or other grain legumes and oilseeds such as rapeseed, sunflower, linseed and others) are used to produce meat like characteristics.

Nevertheless, many existing processes produce texturized meat-analogue food products do not mimic the nutrition, texture, appearance and/or the taste of real meat products. As a result, consumers typically consider such meat-analogue food products to be unappealing and unpalatable.

There is a persisting need for a process of preparing a meat-analogue food product having the appearance, texture and taste of meat. Further there is a need to produce a meat-analogue food product having the appearance, texture and taste of meat with a desired amount of oil, fat or a combination thereof in the resulting composition. Unfortunately, the addition of oil and/or fat to a meat-analogue food product is fraught with difficulties. With higher amounts of oil and/or fat it is difficult to reach a product which has the texture of meat, or it requires hardened, saturated fats and oils (palm oil, coconut oil) that are undesirable from a health perspective.

WO2018/177717 describes a method of preparing a meat analogue comprising combining proteinaceous fibres with an aqueous gelling composition of xanthan gum, galactomannan and water.

The aqueous gelling composition is used to improve the succulence (juiciness) of the meat analogue. This application relates to mincemeat, i.e. burger type meat analogues.

US2007/0269571 describes a processed food based on soybean protein, a gelling agent, which may be a glucomannan, a coagulating agent and water.

KR20180057422 relates to a method of manufacturing vegetable bacon. In the method soy protein is used as the meat part and konjac is the main raw material of the fat part of the bacon.

M. Triki et al. in Meat Science, vol 93 (2013), p 351-360, describe konjac gel as an additive to improve the fat content of fresh sausages (merguez). The sausages contain animal meat as the protein source.

Although meat analogues are described in the documents cited above, it is currently still difficult to achieve a plant based fat that is solid at higher cooking temperature (such as bacon fat) and that can be sliced, cooked and slowly releases oil upon cooking. It is desirable to produce a plant based fat that slowly infuses into a meat analogue and gradually releases oil upon cooking. Furthermore, it is also desirable to produce a plant based fat that is lower in saturated fat that the real meat counterparts and that also has properties that allow browning upon cooking. Furthermore, the product should be crispy on the outside when heated (fried, baked) while maintaining a chewy texture throughout.

The present invention seeks to address these, and other, disadvantages encountered in the prior art by providing an improved fat composition for a meat analogue and a process for preparing such a fat composition.

### SUMMARY

An invention is set out in the independent claims, and optional features are set out in the dependent claims.

According to a first aspect, the present invention relates to a fat composition for meat analogues comprising
0.1-5 wt. % of a glucomannan gum;
2-25 wt. % of a fat;
4-20 wt. % of a browning agent;
0.01-5 wt. % of a coagulating agent;
45-93 wt. % water;
   wherein the wt. % is based on the total weight of the fat composition.

According to a second aspect, the invention relates to a process for producing a plant based fat composition. According to a third aspect, the invention relates to a meat analogue comprising the fat composition.

### DETAILED DESCRIPTION

As described above, the fat composition of the invention comprises a glucomannan gum, a fat, a browning agent, a plant protein, a coagulating agent and water.

Preferably, the amount of glucomannan gum is from 1 to 4 wt. %. Preferably, the amount of fat is from 5 to 12 wt. %. Preferably, the amount of browning agent is from 5 to 15 wt. %. Preferably, the amount of coagulating agent is from 0.05 to 2 wt. %.

The fat composition has a consistency that is such that it is solid enough to stand up on its own and can be easily sliced with a knife. When the fat composition is cooked it turns brown and crisp with and without oil. The final cooked texture is firm to bite with chewy texture inside. The taste is similar to animal fat.

### Glucomannan/Xanthan

Preferably, the glucomannan gum is konjac gum. Konjac gum is a water-soluble hydrocolloid obtained from konjac flour by aqueous extraction. Konjac flour is the un-purified raw product from the tubers of the perennial plant Amorphophallus rivieri also known as Amorphophallus konjac. Konjac flour typically contains at least 75 wt. % glucomannan gum.

The main component of konjac gum is the water-soluble high-molecular-weight polysaccharide glucomannan, which consists of D-mannose and D-glucose units at a molar ration of 1.6:1.0, connected by β(1-4)-glycosidic bonds. Shorter side chains are attached through β(1-3)-glycosidic bonds, and acetyl groups occur at random at a ratio of about 1 group per 9 to 19 sugar units. In the EU, the composition of konjac gum and konjac glucomannan is regulated in Commission Directive 2001/30/EC of 2 May 2001.

The glucomannan gum is preferably used in combination with one or more gelling agents, Typical gelling agents are carrageenan gum, Jerusalem artichoke, psyllium husk, xanthan gum, agar, alginate, carboxymethyl cellulose, casein, guar gum, gellan gum, gelatin, gum arabic, locust bean gum and pectin.

Preferably xanthan gum, agar, guar gum or locust bean gum, more preferably xanthan gum is used as the gelling agent. Xanthan gum is a natural biopolymer produced by Xanthomonas campestris. The advantage of using xanthan gum is that it is tolerant of changes in pH and has a yield point, which means that under a certain stress, the behaviour of the gum changes from elastic to plastic, with a permanent change in shape. This allows capturing of fat globules.

Preferably the fat composition comprises 0.01-2 wt. % gelling agent. The weight ratio gelling agent/glucomannan gum is preferably from 0:100 to 15:85, preferably 2:98 to 10:90. In an alternative preferred embodiment, the weight ratio gelling agent/glucomannan gum is from 20:80 to 40:60.

### Liquid Fat

The term fat as used herein refer to glycerides selected from triglycerides, diglycerides, monoglycerides, phosphoglycerides and combinations thereof. The term fat encompasses fats that are liquid at ambient temperature (commonly also referred to as oils) as well as fats that are solid or semi-solid at ambient temperature (20° C.).

Preferably, a plant based fat is used, preferably selected from the group consisting of shea butter, rapeseed oil, canola oil, corn oil, coconut fat, rice brain oil, safflower oil, sesame oil, peanut oil, sunflower oil, linseed oil, avocado oil, grape seed oil, olive oil and palm fat, and mixtures thereof. The fat may be optionally fully or partly hydrogenated, although unsaturated fats are preferred for their health benefits. It is advantageous if the fat used has a melting point of less than 60° C.

### Browning Agent

To ensure crispiness of the fat composition when baked, a browning agent is added. The browning agent is selected from the group consisting of xylose, arabinose, galactose, fructose, mannose, sucrose, dextrose, lactose, maltose and dextrin. Preferably, a dextrin is used. Dextrins can be produced from starch using enzymes like amylases, or by applying dry heat under acidic conditions. Preferably, a maize dextrin is used.

It was found that the use of dextrin provides crispiness without giving too much sweetness to the final product. It also browns at a good rate during cooking and creates a film on the outside of the fat.

### Coagulating Agent

A coagulating agent is added to de-acylate the glucomannan gum to obtain an irreversible gel of the glucomannan gum. The coagulating agent is selected from sodium carbonate, potassium carbonate, potassium hydroxide, sodium hydroxide and calcium hydroxide. Preferably, calcium hydroxide is used.

### Plant Protein

The fat composition of the invention may further comprise a plant protein, preferably in an amount of 0.5 to 5 wt. % based on the total weight of the fat composition, more preferably 1 to 3 wt. %. The plant protein serves as a binder or emulsifier for the fat/gum composition, but also provides nutrition protein to the composition.

The protein source for the plant protein may be any commonly used plant protein, in particular selected from legume, including pea, bean, chickpea, fava bean; cereal, including soy, wheat, oat and bran; rapeseed; cotton seed; sunflower; sesame; lupin; potato, or mixtures thereof.

Preferred protein sources are soy, potato, pea, fava bean and mixtures thereof. The protein can be granulated or extruded and can also be hydrolysed. In particular, a protein isolate is used such as soy protein isolate. Protein isolate is a highly refined or purified form of protein with a minimum protein content of 90% on a moisture-free basis. In the case of soy, it may be made from defatted soy flour which has had most of the non-protein components, fats and carbohydrates removed.

### Further Ingredients

Further ingredients may be added to the fat composition of the invention. One further ingredient is salt, i.e. kitchen salt (sodium chloride), although the addition of potassium chloride can also be envisaged. The amount of salt may be from 0.1 to 1.5 wt. % based on the total weight of the fat composition. Other further ingredients include flavours, e.g. smoke flavour, herbs, spices, colourants, yeast extract and acidulants, e.g. citric acid, lactic acid. The amount of further ingredients may be from 0 to 5 wt. % based on the total weight of the fat composition.

### Process for Making Fat Composition

According to a second aspect, the present invention provides a process of producing a plant based fat composition, comprising the steps of:
(a1) mixing a glucomannan gum with water to create a mixture;
(b1) adding a liquid fat to the mixture to create an emulsion;
(c) adding a coagulating agent, preferably selected from sodium carbonate, potassium hydroxide, sodium hydroxide and calcium hydroxide to the emulsion, to obtain a final fat composition;
(d) setting the final fat composition,
   wherein the process further comprises adding a browning agent.

According to an alternative embodiment, the process comprises the steps of:
(a2) mixing water and a liquid fat to create an emulsion;
(b2) adding dry glucomannan gum and browning agent to the emulsion;
(c) adding a coagulating agent selected from sodium carbonate, potassium hydroxide, sodium hydroxide and calcium hydroxide to the emulsion, to obtain a final fat composition;
(d) setting the final fat composition.

In particular, the different components are brought together such that the final fat composition comprises
0.1-5 wt. % of the glucomannan gum
2-25 wt. % of the fat
4-20 wt. % of the browning agent
0.05-5 wt. % of the coagulating agent
45-93 wt. % water,
   wherein the wt. % is based on the total weight of the final fat composition. Preferred components of the final fat composition are described above. The total amount of water in the composition is a combination of the water mixed with the glucomannan gum and the water used to add the coagulating agent.

In step (a1) of the process, a glucomannan gum is mixed with water. Preferably, the glucomannan and water are mixed such that a gel is created. In step (a) further a gelling agent, preferably xanthan gum is mixed with the water. The water temperature may be from 15 to 80° C.

In step (b1) the liquid fat is added. In case of a fat with a melting point above room temperature, the fat may be heated to a liquid state, e.g. to a temperature of from 30 to 60° C.

In step (c), the coagulating agent is added to the emulsion as a solution or dispersion in water. The concentration coagulating agent in water may be from 0.5 to 5 wt. %. The amount of coagulating agent added is such that the pH of the final composition is at least 8.

As described above, a browning agent is added in the process. This can be done in step (a) or (b), or as a separate step after step (b) and before adding the coagulating agent.

Further ingredients, including a plant protein, any flavouring agents, salt or other dry ingredients may be added in the process in step (a) or (b), or as a separate step after step (b) and before adding the coagulating agent. Optionally an emulsifier, such as lecithin, may be added in step (a) or (b), to stabilize the oil in water emulsion.

The steps of the process of the invention can be carried out in a mixer or extruder. The mixer is preferably a high shear mixer. Mixing can also be extrusion with the fat coextruded alongside the protein

In step (d) the fat composition is set. This means that the gel becomes irreversible. Setting can be accelerated by cooling or heating. In case of cooling, the final fat composition is kept at a temperature of −18 to 15° C., preferably 0 to 15° C. In case of heating, the fat composition is heated to a temperature from 40 to 100° C., preferably using indirect heat, for instance steam. The duration of step (e) will depend on the specific composition and the temperature applied. Generally, the setting will take from 15 minutes to 12 hours.

### Meat Analogue

In a third aspect, the present invention relates to a plant based meat analogue, comprising 1 to 25 wt. %. of the fat composition according to the invention and 75 to 99 wt. % of a protein source, wherein the wt. % is based on the total weight of the plant based meat analogue. The plant based meat analogue may be any meat analogue containing fat, e.g. bacon, chicken, chorizo, pepperoni, sausage, burger, meatball. Preferred applications are bacon analogues and mincemeat analogues, including burger, sausage and meat ball analogues.

The protein source in the meat analogue provides the protein that would otherwise be provided by animal meat. The protein source may be a protein from plant, fungi, algae, egg, dairy, insects or combinations thereof. Preferably a protein from plants or fungi is used. Plant proteins include pea, bean, chickpea, fava bean; cereal, including soy, wheat, oat and bran; rapeseed; cotton seed; sunflower; sesame; lupin; potato, and mixtures thereof. Preferred plant proteins include soy, pea and fava bean.

The invention also includes a process for making a meat analogue, comprising combining the fat composition of the invention with a protein source. The fat composition can be used in a layered structure with the protein source, or it can be chopped to smaller pieces, for example 2 to 10 mm² cubes, and mixed with the protein source.

### EXAMPLES

### Ingredients

Konjac gum and xanthan gum were obtained from ISI Inc USA, product name BLM1002.

Shea fat was obtained from Bunge, product name Biscuitine 370.

Dextrin was obtained from Cargill, product name C* Dryset 07081

### General Process

A powder blend of konjac, xanthan gum, dextrin and salt was added to water at room temperature (18-23° C. and mixed for about 5 minutes until a thick gel was obtained. The mixture obtained was left to stand for 5 to 20 minutes to hydrate the konjac, further thickening the mixture.

Liquid fat was added gradually while mixing. In case the fat was solid at room temperature (e.g. shea), the fat was melted by heating to about 45° C. If present, in a next step, protein was added while mixing. Then calcium hydroxide in water was added while mixing. pH was measured to check it was at a value of from 8-9. The final mixture obtained was poured in a mould and chilled for 12 hours.

After chilling, the mixture was tested by cooking the mixture in a frying pan on a medium heat for 4 to 6 minutes with regular stirring.

| | Example | | | |
|---|---|---|---|---|
| | 1 and 4 | Example 2 | | |
| | fat = | fat = | | |
| | olive oil | shea | | Comparative |
| Ingredient | % w/w | % w/w | Example 3 | example 1 |
| Water | 71.5 | 80 | 71.5 | 81.5 |
| Fat | 10.8 | 10.8 | 10.8 | 10.8 |
| Dextrin | 10 | 5.7 | 10 | |
| Konjac gum | 2.375 | 2.09 | 2 | 2.375 |
| Xanthan | 0.125 | 0.11 | 0.5 | 0.125 |
| Soy protein isolate | | 1.4 | | |
| Salt (NaCl) | 0.7 | 0.7 | 0.7 | 0.7 |
| Ca(OH)₂* | 0.1 | 0.2 | 0.1 | 0.1 |

*Ca(OH)₂ was added in 7.2 grams of water. This amount of water is included in the total amount of water of the composition.

Examples 1 and 2 gave a fat composition with a white appearance and no lumps with good chewability. Upon cooking, the product gave good browning.

Example 3 gave a firmer texture, less chewing resistance but good browning compared to example 1. Comparative example without dextrin contained gel lumps. Upon cooking, the product gave a slight browning on the outside but no caramelisation or formation of a chewy outer film.

Example 4 had the same composition as example 1, but the konjac, xanthan, dextrin and salt were added to water at a temperature of 60° C. The result was the same as for example 1.

Meat analogues were prepared by mixing the following compositions and forming the respective shapes of the meat analogue.

| | | | | Example 8 |
|---|---|---|---|---|
| | Example 5 | Example 6 | Example 7 | Sausage |
| | Sausage | Pork | Lamb | patty |
| | analogue | analogue | analogue | analogue |
| Ingredient | % w/w | % w/w | % w/w | % w/w |
| Fat composition | 3 | 10 | 10 | 10 |
| of example, diced | | | | |
| into chunks | | | | |
| varying from | | | | |
| 2 mm² to 15 mm² | | | | |
| Mix mushroom | 95.4 | 88.6 | 87.35 | 88.4 |
| and pea protein | | | | |
| Flavour | 1.6 | 1.4 | 2.65 | 1.6 |

The meat analogues were cooked in a frying pan on a medium heat for 4 to 6 minutes and were turned and flipped half way through the cooking time. The resulting cooked meat analogues had a brown crispy exterior and a juicy, meaty interior.

Alternatively, the meat analogues can be cooked in the oven at 180° C. for 8 minutes.

### Example 9

| Ingredient | Supplier | Example 9 (g) |
|---|---|---|
| Water (bulk) | Britta Filter | 664 |
| Olive Oil | Light in color | 108 |
| White dextrin C* Dry Set 07081 | Brentagg/Cargill | 100 |
| Gelling agent, konjac | Neutraceuticals | 24 |
| Empro E86 Pea Protein | Healy Group | 14 |
| Xanthan Gum | Neutraceuticals | 10 |
| Salt | Tesco | 7 |
| Gelling aid Ca(OH)₂ | Neutraceuticals | 1 |
| Water (added with gelling aid) | N/A | 72 |
| TOTAL | | 1000 |

A fat composition was prepared according to the following process: water and oil were mixed together in a high shear mixer. Pre-blended powders of glucomannan gum, white dextrin, xanthan gum, pea protein, and salt were mixed into the water-oil mixture for 3 minutes. Ten minutes were given for the gums to hydrate without mixing. Then the gelling aid (CaOH2) and water were pre-mixed and added to the mixture with 3 mins of mixing.

After cooking the fat composition had a bite and was succulent and moist.

### Comparative Example 2

A fat formulation was prepared according to KR20180057422 having the following composition

| | | Comp. | % of |
|---|---|---|---|
| Ingredients | Supplier | Ex. 2 (g) | total |
| Konjac | | 71 | 7.10 |
| Carrageenan | Iota (ceamse) | 23.4 | 2.34 |
| Xanthan gum | Nutraceuticals | 11.8 | 1.18 |
| Starch acetate | Modified potato starch (Ingredion) | 11.8 | 1.18 |
| | selectamyl D20 | | |
| Salt | | 5.4 | 0.54 |
| Sugar | Dextrose | 10.8 | 1.08 |
| Vegetable oil | | 21.5 | 2.15 |
| Water | | 755 | 84.3 |
| | | +88 | |
| Ca(OH)₂ | | 1.2 | 0.12 |

The dry ingredients were pre-mixed and then mixed with water a high shear mixed for 5 minutes. After 10 minutes of rest, the CaOH2 mixture was added with mixing. The mixture was cooked for 30 minutes at a temperature of 80˜100° C. by putting fat composition in a vacuum bag in water of 100° C.

The fat composition obtained was beige and firm, dough-like. It was not pasty or sticky. After cooking the fat composition was dense, chewy and very tough.

### Comparative Example 3

A fat composition was prepared according to Table 2 of Osburn, W. N., & Keeton, J. T. (2004), Meat Science, 68(2), 221-233. (cited in M. Triki et al. in Meat Science, vol 93 (2013), p 351-360).

| | | Comp. | % of |
|---|---|---|---|
| Ingredients | Supplier | Ex. 3 (g) | total |
| Konjac | | 50 | 5 |
| water | | 800 | 80 |
| iota- carrageenan | Ceamsa | 10 | 1.00 |
| pre-gelled | Coldswell 1111 | 30 | 3 |
| cornstarch | pre-gelled potato | | |
| powder | starch | | |
| CaOH | Added at 1% as a | 1 g | 0.1 |
| | 10% solution | | |
| Water | | 109 | 10.9 |

The dry ingredients were pre-mixed and then mixed with water a high shear mixed for 5 minutes. After 10 minutes of rest, the CaOH2 mixture was added with mixing.

The fat composition obtained was sticky and almost clear (transparent). After cooking, the fat composition was chewy and gummy.

### Sensory Testing

A blind sensory panel with 10 employees of THIS was conducted to compare the fat compositions of Example 9, Comparative Example 2 and Comparative Example 3. Panellists were asked to rate each product individually using each of the listed attributes on a 9-point scale. Averages of each value are reported along with the p-value t-test comparison.

| | | Comparative | | Comparative | |
|---|---|---|---|---|---|
| | Example 9 | Example 2 | | Example 3 | |
| Attribute | AVG | AVG | p-value | AVG | p-value |
| Hyper-realism to pork fat | 3 | 5 | 0.00002 | 2 | 0.07722 |
| colour | | | | | |
| Level of caramelisation/ | 7 | 5 | 0.00154 | 4 | 0.00009 |
| browning | | | | | |
| Hedonic liking | 7 | 3 | 0.00000 | 2 | 0.00000 |
| Firmness | 6 | 4 | 0.03379 | 7 | 0.16040 |
| Crispness | 6 | 3 | 0.00701 | 3 | 0.04742 |
| Succulence | 3 | 5 | 0.11340 | 3 | 0.47909 |
| Chewiness | 6 | 4 | 0.02956 | 5 | 0.74171 |

The product of the invention scored significantly higher for liking on the hedonic scale (7 vs 3 or 2) and significantly higher for crispness and browning (6 and 7 vs. 3 and 5/4 respectively).

### Freeze Thaw Water Loss

In a further test, the fat compositions of Example 9, Comparative Example 2 and Comparative Example 3 were subjected to a cycle of freezing and thawing. Both Comparative Example 2 and 3 showed significant water loss after freezing and thawing. The formulations were significantly softer after freeze-thawing compared to samples stored in a fridge. The freeze-thaw water loss did not occur with the product of Example 9.

1. A fat composition, comprising
0.1-5 wt. % of a glucomannan gum;
2-25 wt. % of a fat;
4-20 wt. % of a browning agent;
0.01-5 wt. % of a coagulating agent;
45-93 wt. % water;
wherein the wt. % is based on the total weight of the fat composition.

2. The fat composition according to claim 1, comprising
5-12 wt. % of the fat.

3. The fat composition according to claim 1 or 2 wherein the glucomannan gum is konjac gum.

4. The fat composition according to claim 1 or 2, further comprising a gelling agent, preferably xanthan gum, agar, guar gum or locust bean gum, more preferably xanthan gum.

5. The fat composition according to claim 4, comprising 0.01-2 wt. % of a gelling agent.

6. The fat composition according to any one of the preceding claims, further comprising a plant protein, preferably 0.5-5 wt. % plant protein based on the total weight of the fat composition.

7. The fat composition according to claim 6, wherein the plant protein is a protein obtained from legume, potato, soy or a mixture thereof.

8. The fat composition according to any one of the preceding claims, wherein the browning agent is a dextrin.

9. The fat composition according to any one of the preceding claims, wherein the coagulating agent is selected from sodium carbonate, potassium hydroxide, sodium hydroxide and calcium hydroxide, preferably calcium hydroxide.

10. Meat analogue comprising 1 to 25 wt. %. of the fat composition according to any one of the preceding claims and 75 to 99 wt. % of a protein source, wherein the wt. % is based on the total weight of the meat analogue.

11. Meat analogue according to claim 10, which is a bacon analogue or mincemeat analogue, including burger, sausage and meat ball analogues.

12. A process of producing a plant based fat composition, comprising the steps of:
(a) mixing a glucomannan gum with water to create a mixture;
(b) adding a liquid fat to the mixture to create an emulsion;
(c) adding a coagulating agent preferably selected from sodium carbonate, potassium hydroxide, sodium hydroxide and calcium hydroxide, more preferably calcium hydroxide, to the emulsion, to obtain a final fat composition;
(d) setting the final fat composition;
wherein the process further comprises adding a browning agent.

13. The process of claim 12, wherein the final fat composition comprises
0.1-5 wt. % of the glucomannan gum
2-25 wt. % of the fat
4-20 wt. % of the browning agent
0.01-5 wt. % of the coagulating agent
45-93 wt. % water,
wherein the wt. % is based on the total weight of the final fat composition.

14. The process according to claim 12 or 13, wherein the glucomannan gum is combined with a gelling agent, preferably xanthan gum.

15. The process according to any one of claims 12 to 14, further comprising adding a plant protein.

16. The process according to any one of claims 12 to 15, wherein the coagulating agent is added to obtain a pH of the final composition of at least 8.
